(19) United States
(12) Patent Application Publication
(10) Pub. No.: US 2025/0200962 A1
(43) Pub. Date: Jun. 19, 2025

(54) MICROSERVICES BASED NO-CODE AI SOLUTION

(71) Applicant: Fidelity Information Services, LLC, Jacksonville, FL (US)

(72) Inventors: Angad Singh Bagga, Punjab (IN); Mayur Ashish Shiradhonkar, Maharashtra (IN); Rajendran Subramanian, Tamil Nadu (IN); Sudhanshu Shukla, Uttar Pradesh (IN); Gopal Krushna Padhi, Odisha (IN)

(21) Appl. No.: 18/545,696

(22) Filed: Dec. 19, 2023

(51) Int. Cl. G06V 10/94; G06F 40/58; G06T 11/60; G06V 10/82; G06V 30/19

(52) U.S. Cl. CPC G06V 10/95; G06F 40/58; G06T 11/60; G06V 10/82; G06V 30/19093

(57) ABSTRACT

The present disclosure relates methods and systems for artificial intelligence (AI) and machine learning (ML). An example method performed by one or more computers includes receiving a request associated with a plurality of AI services. Each of the plurality of AI services is associated with one or more of a plurality of ML models. At least one of the plurality of ML models is trained by predetermined guidelines. The method further includes providing for presentation, via a front end, the plurality of AI services. The method further includes receiving a user input through the front end, where the user input indicates selection of one of the plurality of AI services. The method further includes providing for presentation, via the front end, an AI service-specific input interface. Each of the plurality of AI services is associated with a corresponding AI service-specific input interface.

### TECHNICAL FIELD

The present disclosure relates to artificial intelligence (AI) and machine learning (ML).

### BACKGROUND

Artificial intelligence (AI) technology has been widely integrated into various industries. AI can be used to process massive datasets and to automate complex tasks traditionally performed by humans, and thus can significantly improve efficiency and productivity in many ways. In general, creating an AI-based application or service, or incorporating AI or ML into existing applications, requires extensive technical expertise. The expertise may include, for example, mastery of machine learning and data science, a deep knowledge of mathematics and statistics, and programming skills to develop computer algorithms. Furthermore, training a model used by the AI service may need a large amount of labeled data. As such, development and deployment of AI services can be time-consuming and a challenge for potential users with little or no requisite background.

### SUMMARY

The present disclosure relates to methods and systems for artificial intelligence (AI) and machine learning (ML). An example method performed by one or more computers includes receiving a request associated with a plurality of AI services. Each of the plurality of AI services is associated with one or more of a plurality of ML models. At least one of the plurality of ML models is trained by predetermined guidelines. The method further includes providing for presentation, via a front end, the plurality of AI services. The method further includes receiving a user input through the front end, where the user input indicates selection of one of the plurality of AI services. The method further includes providing for presentation, via the front end, an AI service-specific input interface. Each of the plurality of AI services is associated with a corresponding AI service-specific input interface. The method further includes receiving input data for the selected AI service through the AI service-specific input interface presented via the front end. The method further includes in response to receiving the input data, generating output data by applying one or more ML models associated with the selected AI service to the input data. The method further includes providing for presentation, via the front end, the output data.

In some instances, the selected AI service includes a first service for automatic image generation, the input data includes a text description of a desired image, and the first service is associated with an image generation ML model trained by the predetermined guidelines. In some of those instances, generating the output data includes, in response to determining selection of the first service, validating the text description based on the predetermined guidelines, and generating an image as the output data by applying the image generation ML model to the text description.

In some instances, the selected AI service includes a second service for automatic presentation slide creation, the input data includes one or more text descriptions, and the second service is associated with a large language model (LLM) and an image generation ML model. Each of the one or more text descriptions describes a page of a desired presentation. The image generation ML model is trained by the predetermined guidelines. In some of those instances, generating the output data includes, in response to determining selection of the second service, for each text description of the one or more text descriptions, validating the text description based on the predetermined guidelines, generating text content by applying the LLM to the text description, generating an image by applying the image generation ML model to the text description, and generating a slide comprising the text content and the image. Generating the output data further includes generating a combination of each generated slide as the output data.

In some instances, the selected AI service includes a third service for text extraction from image, the input data includes a user request and an image, and the third service is associated with a convolutional neural network (CNN) model and a transformer model. In some of those instances, generating the output data includes, in response to determining selection of the third service, generating text by applying the CNN model to the image, determining a similarity value between the generated text and the user request by applying the transformer model to the generated text and the user request, determining a boundary based on the similarity value, and generating the output data by applying the CNN model to the image within the boundary.

In some instances, the selected AI service includes a fourth service for data mining, and the fourth service includes one or more of following functions: regression, classification, time series forecasting, or clustering.

In some instances, the selected AI service includes a fifth service for statistical analysis, and the fifth service includes one or more of following functions: data distribution, anomaly, missing values, data drift, correlation matrix, mean, median mode, or business intelligence (BI) data analysis.

In some instances, the selected AI service includes a sixth service for automatic ML model deployment, and the input data indicates selection of a desired ML model. Generating the output data includes, in response to determining selection of the sixth service, determining a prediction script based on the desired ML model, determining a representational state transfer (REST) application programming interface (API), and generating a docker image for the desired ML model as the output data, wherein the docker image is generated based on the prediction script and the REST API.

In some instances, the method further includes updating the plurality of AI services, receiving a second request associated with the updated plurality of AI services, and providing for presentation, via the front end, the updated plurality of AI services. In some of those instances, updating the plurality of AI services includes one or more of: adding a new AI service to the plurality of AI services and adding one or more new ML models associated with the new AI service to the plurality of ML models, removing an AI service from the plurality of AI services and removing one or more ML models associated with the removed AI service from the plurality of ML models, replacing one or more ML models associated with one of the AI services with one or more new ML models, replacing the predetermined guidelines with new guidelines and updating the at least one of the plurality of ML models by training the at least one of the plurality of ML models using the new guidelines.

An example system includes one or more computers, and one or more storage devices storing instructions that when executed by the one or more computers cause the one or more computers to perform operations. The operations include receiving a request associated with a plurality of AI services. Each of the plurality of AI services is associated with one or more of a plurality of ML models. At least one of the plurality of ML models is trained by predetermined guidelines. The operations further include providing for presentation, via a front end, the plurality of AI services. The operations further include receiving a user input through the front end, where the user input indicates selection of one of the plurality of AI services. The operations further include providing for presentation, via the front end, an AI service-specific input interface. Each of the plurality of AI services is associated with a corresponding AI service-specific input interface. The operations further include receiving input data for the selected AI service through the AI service-specific input interface presented via the front end. The operations further include in response to receiving the input data, generating output data by applying one or more ML models associated with the selected AI service to the input data. The operations further include providing for presentation, via the front end, the output data.

In some instances, the selected AI service includes a first service for automatic image generation, the input data includes a text description of a desired image, and the first service is associated with an image generation ML model trained by the predetermined guidelines. In some of those instances, generating the output data includes, in response to determining selection of the first service, validating the text description based on the predetermined guidelines, and generating an image as the output data by applying the image generation ML model to the text description.

In some instances, the selected AI service includes a second service for automatic presentation slide creation, the input data includes one or more text descriptions, and the second service is associated with a LLM and an image generation ML model. Each of the one or more text descriptions describes a page of a desired presentation. The image generation ML model is trained by the predetermined guidelines. In some of those instances, generating the output data includes, in response to determining selection of the second service, for each text description of the one or more text descriptions, validating the text description based on the predetermined guidelines, generating text content by applying the LLM to the text description, generating an image by applying the image generation ML model to the text description, and generating a slide comprising the text content and the image. Generating the output data further includes generating a combination of each generated slide as the output data.

In some instances, the selected AI service includes a third service for text extraction from image, the input data includes a user request and an image, and the third service is associated with a CNN model and a transformer model. In some of those instances, generating the output data includes, in response to determining selection of the third service, generating text by applying the CNN model to the image, determining a similarity value between the generated text and the user request by applying the transformer model to the generated text and the user request, determining a boundary based on the similarity value, and generating the output data by applying the CNN model to the image within the boundary.

One or more non-transitory computer-readable storage media store instructions that when executed by one or more computers cause the one or more computers to perform operations. The operations include receiving a request associated with a plurality of AI services. Each of the plurality of AI services is associated with one or more of a plurality of ML models. At least one of the plurality of ML models is trained by predetermined guidelines. The operations further include providing for presentation, via a front end, the plurality of AI services. The operations further include receiving a user input through the front end, where the user input indicates selection of one of the plurality of AI services. The operations further include providing for presentation, via the front end, an AI service-specific input interface. Each of the plurality of AI services is associated with a corresponding AI service-specific input interface. The operations further include receiving input data for the selected AI service through the AI service-specific input interface presented via the front end. The operations further include in response to receiving the input data, generating output data by applying one or more ML models associated with the selected AI service to the input data. The operations further include providing for presentation, via the front end, the output data.

### DESCRIPTION OF DRAWINGS

FIG. 1 illustrates an example no-code artificial intelligence (AI) system, according to some aspects of the present disclosure.

FIG. 2 illustrates example functions of the system of FIG. 1, according to some aspects of the present disclosure.

FIG. 3 illustrates a flowchart of an example method, according to some aspects of the present disclosure.

FIG. 4 illustrates a flowchart of another example method, according to some aspects of the present disclosure.

FIGS. 5A-5C show diagrams illustrating an example AI service for automatic image generation, according to some aspects of the present disclosure.

FIGS. 6A-6B show diagrams illustrating an example AI service for automatic presentation slide creation, according to some aspects of the present disclosure.

FIGS. 7A-7B show diagrams illustrating an example AI service for text extraction from image, according to some aspects of the present disclosure.

FIG. 8 illustrates an example flowchart of a method for providing an example AI service for automatic machine learning (ML) model deployment, according to some aspects of the present disclosure.

### DETAILED DESCRIPTION

Artificial intelligence (AI) can be used to process large data sets and to automate complex tasks traditionally performed by humans, and thus, can significantly improve a user's efficiency and productivity for many time-consuming and repetitive tasks. Various AI-based applications or services (also referred to as AI services) can be used in different tasks or at different stages of one task. However, a process to build or find appropriate AI services for a given task can be cumbersome, particularly for non-technical users. For example, a business team of a company or an organization may have a task to create a presentation to illustrate a forecast analysis result of a dataset. The dataset can include structured data, or the business team can obtain the structured data after preprocessing the dataset and performing statistical exploration. Then, the business team can request a data science team of the company to provide an AI service for forecasting (e.g., using a machine learning (ML) model for time series forecasting). After applying the AI service for forecasting to the dataset and obtaining the forecast analysis result, the business team can use another AI service for presentation generation, which can also be provided by the data science team, or, in some cases, by a third party. The company may require content of the generated presentation to follow some internal guidelines (e.g., for branding purposes). If the generated presentation does not comply with the internal guidelines, the business team may need to manually revise the generated presentation or request the data science team to modify the AI service for presentation generation. In this task, the business team may have to rely on and work with the data science team to obtain suitable AI services, which can be limiting and time-consuming. To improve the efficiency of this process, it is desired to have data preprocessing tools and various AI services available at one place so that users (including those with no development and/or programming skills) can access them with ease.

The present disclosure describes a system for no-code AI. In one example implementation, the system displays a variety of AI services through a front end upon request. The AI services can use different ML models, and some of the ML models are trained by predetermined guidelines. A user interacts with the front end and select one of these AI services, and the system provides a specific input interface tailored to the selected AI service. After receiving input data for the selected AI service through the input interface, the system applies corresponding ML models and generates output data, which is presented to the user via the front end.

The no-code AI system described in this disclosure can be implemented to realize one or more of the following advantages. This system can provide various AI services in a centralized location, such as in a portal or website, where each of the AI services may be available as no-code solutions. Thus, users, including those with little-to-no technical skills, have direct and easy access to the AI services. In some instances, the system can include AI service modules implemented as microservices. The microservice based framework allows an individual module/microservice to be integrated into or taken out of the framework in a plug-and-play fashion, thereby providing flexibility and scalability. For example, it is easier to update one of the AI service modules (e.g., updating a corresponding ML model) or add a new AI service module to the system without affecting existing functions of the system. The system can provide AI services for automatic content generation using ML models trained by predetermined guidelines. The predetermined guidelines can be based on internal company standards or policies, and can be managed by users and administrators in accordance with defined requirements. As such, users of the AI service for automatic content generation can focus on the quality of their work by avoiding needing to manually check whether their formats or content of their work violate the internal company policies. The system also provides interactive AI-service based user interfaces (UIs) and a no-code solution, which allows the user to receive the benefits of each of the available AI services through relatively simple inputs without coding, programming, or managing the AI or ML service, themselves. Furthermore, the AI services provided by the system can be accessible to various users including both employees and clients of a company.

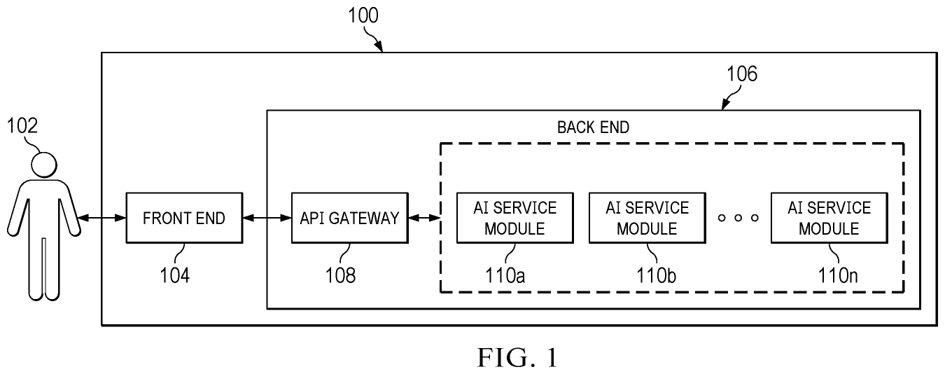

FIG. 1 illustrates an example no-code AI system 100 (also referred to as the system), according to some aspects of the present disclosure. The system 100 is an example of a system implemented as computer programs on one or more computers in one or more locations, in which components and techniques described below can be implemented. The system 100 is configured to provide AI services to a user 102. The user 102 can be an employee of a company who is planning to improve the quality and/or productivity of his/her work using one of the AI services.

As shown in FIG. 1, the system 100 includes a front end 104 and a back end 106. The front end 104 can be a suitable component through which the user 102 can interact with the system 100. For example, the front end 104 can be a computer having a graphical user interface (GUI). The term GUI can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user 102. In general, a GUI can include a number of user interface (UI) elements, some or all associated with a web browser, such as interactive fields, pull-down lists, and buttons. These and other UI elements can be related to or represent the functions of the web browser.

The back end 106 can be configured to process requests and input data from the user 102 and generate responses and output data. The back end 106 can include an application programming interface (API) gateway 108 and AI service modules 110a-110n. The API gateway 108 is configured to pass the input data from the front end 104 to the AI service modules 110a-110n, and to return the output data generated by the AI service modules 110a-110n to the front end 104. In some implementations, the API gateway 108 can route a request to one of the AI service modules 110a-110n suitable for handling the request. In some implementations, the API gateway 108 can split a single request into multiple sub-requests, and can call multiple AI service modules to process the multiple sub-requests. In some implementations, the API gateway can provide other functions such as authentication, monitoring, billing, and rate limiting.

Each of the AI service modules 110a-110n is configured to provide a specific AI service. The AI services provided by the AI service modules 110a-110n can include, for example, automatic image generation, automatic presentation slide creation, text extraction from image, data mining tools, statistical analysis tools, and automatic ML model deployment. In some implementations, the data mining tools can include regression, classification, time series forecasting, and clustering. In some implementations, the statistical analysis tools can include data distribution, anomaly, missing values, data drift, correlation matrix, mean, median mode, or business intelligence (BI) data analysis. Any suitable AI service module 110n may be added to or removed from the backend 106 by administrators, thereby allowing a curated, but non-static set of services to be provided. The solution allows administrators to be responsive to their users, adding new features or removing an existing feature.

Each AI service can be associated with one or more ML models. When the user 102 selects an AI service, a corresponding AI service module can generate the output data by applying the one or more ML models associated with the AI service to the input data from the user 102. In some implementations, the ML models associated with the AI services can be implemented using open-source ML libraries such as Pycarat and FeatureTools. In some other implementations, the ML models can be custom models built and trained by the user 102, another team of the company, or even another company.

In some implementations, an ML model associated with an AI service provided by the system 100 is trained by predetermined guidelines. The predetermined guidelines can be a set of standards or rules established by a company to regulate content (such as text, images, and presentation slides) associated with the company. For example, for branding purposes, the company may require its employees to apply uniform styles (e.g., specific layouts or templates, background styles, font, and color combinations) to their presentation slides. In another example, the company may have policies that prohibit use of certain text or images (e.g., sensitive or abusive languages) in internal documents. An AI service for automatic content (e.g., images or presentations) generation can use an ML model trained by these predetermined guidelines to ensure that the generated content automatically complies with the internal company policies. Accordingly, users of the AI service can focus on quality of their work rather than spending too much time manually checking whether formats or content of the work may violate the internal policies.

In some implementations, the AI service modules 110a-110n can be implemented as microservices coupled together. Each of the AI service modules can be a microservice that is coupled to and communicates with other AI service modules and the API gateway 108. A microservice can refer to an independent computer program that performs a specific function. A combination of multiple microservices (e.g., being coupled through some predetermined APIs) can form a larger and more complicated application. In addition, the microservices can be developed and deployed independently from each other. Such a microservice based framework can provide flexibility and scalability to the system 100. For example, this framework can make it easier to update one of the AI service modules (e.g., updating a corresponding ML model) or add a new AI service module to the system 100 without affecting existing functions of the system 100.

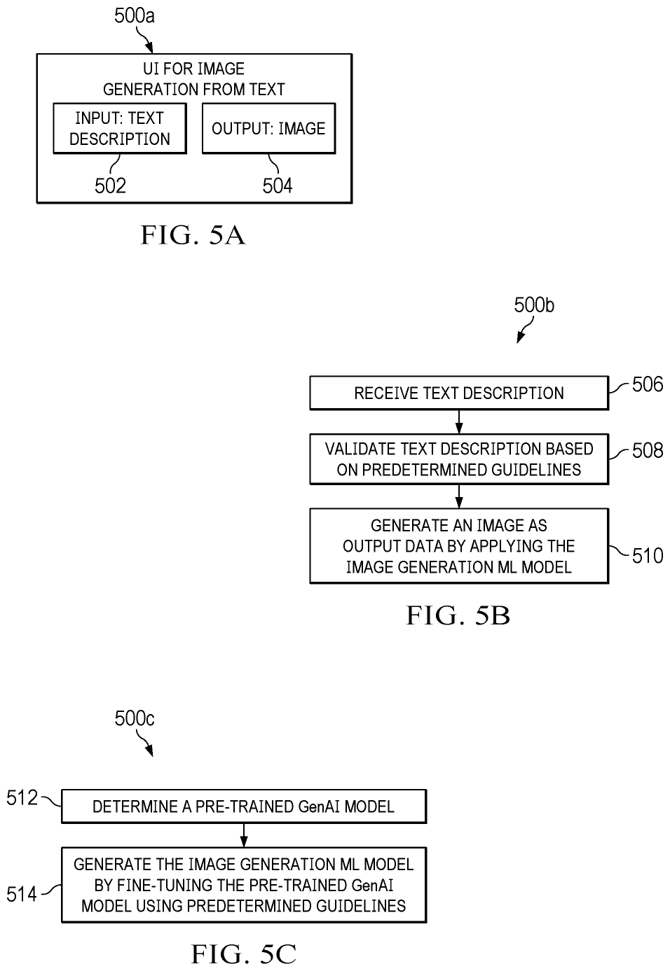

Examples of functionalities of the AI service modules 110a-110n are described with further details with respect to FIGS. 5A-5C, 6A-6B, 7A-7B, and 8.

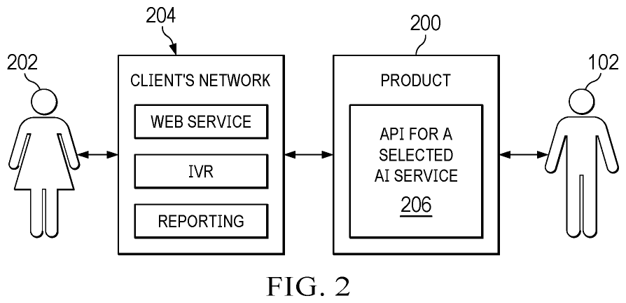

FIG. 2 illustrates example functions of the system 100 of FIG. 1, according to some aspects of the present disclosure. In some implementations, as shown in FIG. 2, an AI service provided by the system 100 can be integrated into the company's product 200 and thus can be accessed by a client 202 (or a customer) of the company. In some instances, the user 102 can be associated with a product team (e.g., a development group of the product 200) of the company. The user 102 may identify that one of the AI service modules 110a-110n in the system 100 provides an AI service that satisfies a requirement of the client 202. For example, an AI service for forecasting can be used by the client 202 for a service-related task such as a web service, an interactive voice response (IVR) service, or a reporting service, etc. The user 102 may select the AI service and submit a request (e.g., via the front end 104) to the system 100 to add the selected AI service to the product 200. In response to the request, the system 100 can generate an API 206 for the selected AI service, which can be integrated into the product 200 as a feature. Then, the client 202 can access (e.g., through the client's network 204) the API 206 for the selected AI service.

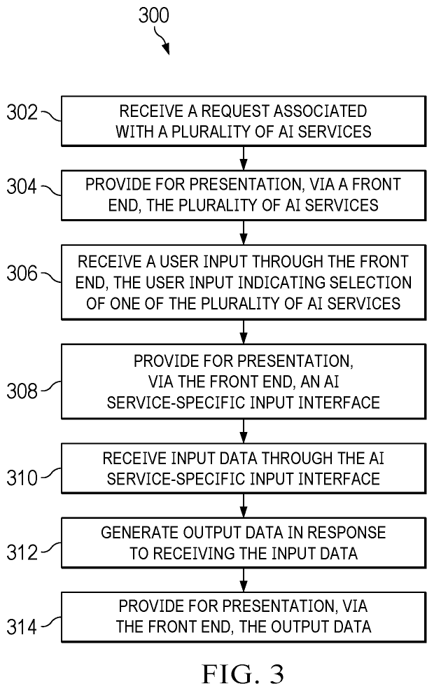

FIG. 3 illustrates a flowchart of an example method 300, according to some aspects of the present disclosure. For convenience, the method 300 will be described as being performed by a system of one or more computers located in one or more locations (e.g., the system 100 of FIG. 1).

At 302, the system receives a request associated with a plurality of AI services. The request can be a request from a user (e.g., user 102 of FIG. 1) of the system to view or browse available AI services provided by the system. In some implementations, the system can receive the request via a front end (e.g., front end 104 of FIG. 1) of the system. In some implementations, each of the plurality of AI services is associated with one or more of a plurality of ML models. At least one of the plurality of ML models can be trained by predetermined guidelines.

In some implementations, the plurality of AI services include one or more of a service for automatic image generation, a service for automatic presentation slide creation, a service for text extraction from image, a service for data mining, a service for statistical analysis, or a service for automatic ML model deployment. In some instances, the service for data mining can include one or more of the following functions: regression, classification, time series forecasting, or clustering. In some instances, the service for statistical analysis can include one or more of the following functions: data distribution, anomaly, missing values, data drift, correlation matrix, mean, median mode, or BI data analysis.

At 304, the system provides for presentation, via the front end, the plurality of AI services. For example, the front end may include a GUI, which presents the plurality of AI services to the user. The presentation may be through a web or intranet portal or website, where the plurality of AI services may be made available for use and interaction.

At 306, the system receives a user input through the front end. The user input can indicate selection of one of the plurality of AI services. The GUI of the front end can notify the system in response to the user input, for example, when the user clicks a button in the GUI associated with the selected AI service.

At 308, the system provides for presentation, via the front end, an AI service-specific input interface in response to the selection. In some implementations, each of the plurality of AI services is associated with a corresponding AI service-specific input interface, each of which may be presented or made available in response to receiving a selection associated with that specific AI service.

At 310, the system receives input data for the selected AI service through the AI service-specific input interface presented via the front end. The input data can be specific to the particular AI service. Various examples are described here. For example, the input data can include a text description of a desired image when an AI service for automatic image generation is selected. When an automatic presentation slide creation service is selected, the input data can include one or more text descriptions each describing a page of a desired slide show. If an image text extraction service is selected, then the input data can include an image or image file. The input data can include selection of a desired ML model when an AI service for automatic ML model deployment is selected. The input data can include a database file (e.g., an Excel sheet or a database in any other formats) or a link to the database file when an AI service for data mining or statistical analysis is selected.

At 312, in response to receiving the input data, the system generates output data by applying one or more ML models associated with the selected AI service to the input data. The output data can be generated by an AI service module (e.g., the AI service modules 110a-110n of FIG. 1) of the system.

At 314, the system provides for presentation, via the front end, the output data. The output data can be presented through an AI service-specific output interface associated with the AI service-specific input interface. In some implementations, the AI service-specific input interface and the corresponding AI service-specific output interface can be integrated into one interface (e.g., an interface including a region for input interface and another region for output interface).

In some implementations, the system can update the plurality of AI services. For example, the system can add a new AI service to the plurality of AI services, and add one or more new ML models associated with the new AI service to the plurality of ML models.

In some instances, the system can remove an AI service from the plurality of AI services and remove one or more ML models associated with the removed AI service from the plurality of ML models.

In some other instances, the system can replace one or more ML models associated with one of the AI services with one or more new ML models.

In some other instances, the system can replace the predetermined guidelines with new guidelines and update the at least one of the plurality of ML models by training the at least one of the plurality of ML models using the new guidelines.

The updating process can be implemented at a back end (e.g., the back end 106 of FIG. 1) of the system. In some implementations, the user interacts with the front end of the system, and may not be involved in or aware of the updating process. After the updating process is complete, the system may receive another request (referred to as a second request) associated with the updated plurality of AI services. In some instances, the second request can be another request from the user to check available AI services, while in others, the second request can be a new request from a second user different than the first. In response to the second request, the system can provide for presentation, via the front end, the updated plurality of AI services. In some implementations, the system may provide for presentation, via the front end, an update history to notify the user of recent changes to the system (e.g., an AI service being removed, or an ML model of an existing AI service being modified).

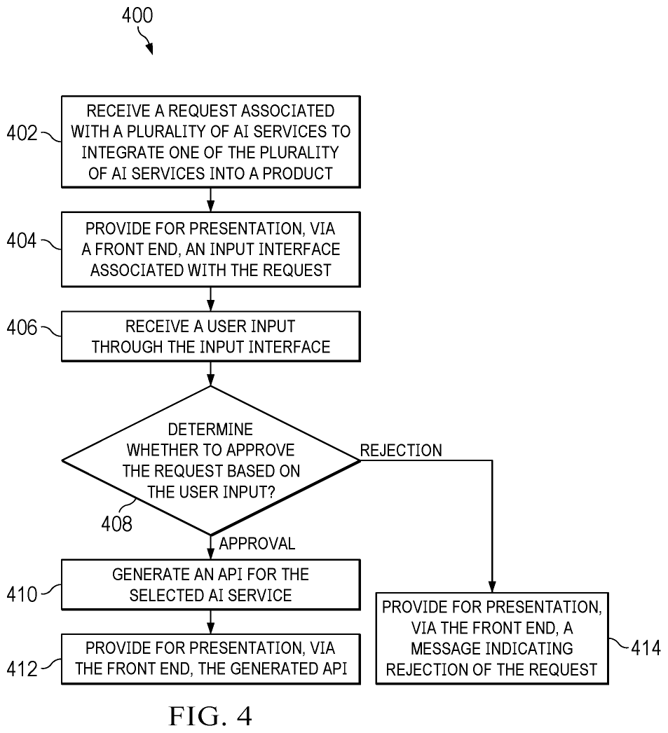

FIG. 4 illustrates a flowchart of an example method 400, according to some aspects of the present disclosure. For convenience, the method 400 also will be described as being performed by a system of one or more computers located in one or more locations (e.g., the system 100 of FIG. 1). The method 400 can be described with reference to FIG. 2.

At 402, the system receives a request associated with a plurality of AI services. The system can receive the request after presenting the plurality of AI services to a user (e.g., user 102 of FIG. 2) of the system. The request can indicate selection of one of the plurality of AI services. The request can be a request from the user of the system to integrate the selected AI service into a product (e.g., the product 200 of FIG. 2). The user can be associated with a development team of the product. In some implementations, the system can receive the request via a front end (e.g., front end 104 of FIG. 1) of the system.

At 404, the system provides for presentation, via the front end, an input interface associated with the request.

At 406, the system receives a user input through the input interface. The user input can include one or more of a role of the user in the development team, description of the product, or specific reasons for integrating the selected AI service into the product.

At 408, the system determines whether to approve the request based on the user input.

If the system approves the request, the method 400 proceeds to 410, where the system generates an API for the selected AI service. From 410, the method proceeds to 412. At 412, the system provides for presentation, via the front end, the generated API for the selected AI services. The generated API can be integrated into the product.

Otherwise, if the system rejects the request, the method 400 proceeds to 414. At 414, the system provides for presentation, via the front end, a message indicating rejection of the request.

FIGS. 5A-5C show diagrams illustrating an example AI service for automatic image generation, according to some aspects of the present disclosure. FIG. 5A illustrates an example UI 500a associated with the AI service for automatic image generation. FIG. 5B illustrates an example flowchart of a method 500b for providing the AI service for automatic image generation. FIG. 5C illustrates an example flowchart of a method 500c for generating an image generation ML model. In some implementations, the image generation ML model generated by the method 500c and the UI 500a as shown in FIG. 5A can be used in the method 500b.

The UI 500a can be an example of the AI service-specific input interface described in 308 of FIG. 3. As shown in FIG. 5A, the UI 500a includes an input text box 502, which is configured to receive input data for the AI service for automatic image generation from a user (e.g., the user 102 of FIG. 1). In some implementations, the input data includes a text description of a desired image. In some implementations, the UI 500a further includes an output image box 504, which is configured to present a generated image to the user.

The method 500b can be performed by an AI service module (e.g., one of the AI service modules 110a-110n of FIG. 1) of a no-code AI system (e.g., the system 100 of FIG. 1) described in the present disclosure. The method 500b begins at 506, after the specific AI service has been selected from the plurality of AI services, where the AI service module receives a text description of a desired image as input. In some implementations, the system receives the text description through an AI-specific input interface (e.g., the input text box 502 of FIG. 5A) presented via a front end (e.g., the front end 104 of FIG. 1) and forwards the text description to the AI service module (e.g., through the API gateway 108 of FIG. 1).

At 508, the AI service module validates the text description based on predetermined guidelines. The predetermined guidelines can be a set of standards or rules established by a company to regulate content (such as text, images, and presentation slides) associated with the company. For example, the company may have policies that prohibit use of certain text or images (e.g., sensitive or abusive languages) in internal documents.

At 510, the AI service module generates an image as output data by applying an image generation ML model to the text description. The system can provide the generated image for presentation via an interface (e.g., the output image box 504 of FIG. 5A) presented at the front end.

In some implementations, the image generation ML model is a custom ML model generated by the method 500c of FIG. 5C. The method 500c can be performed by the no-code AI system described in the present disclosure. In some other implementations, the method 500c can be performed by any suitable system known in the art that is dedicated for ML model training. At 512 of method 500c, a generative AI (GenAI) model is determined. The GenAI model can be a pre-trained generative model for text-to-image AI generation known in the art such as Stable Diffusion, Midjourney, and DALL-E. At 514, the image generation ML model can be generated by fine-tuning the GenAI model using the predetermined guidelines. In some implementations, the GenAI model can be fine-tuned by performing the following operations using text prompts and custom images. The custom images represent images described by the text prompts and comply with the predetermined guidelines. The images are converted into embedding representations (also referred to as latent representations). The text prompts are encoded through a text-encoder and then are fed into a latent diffusion model via multiple attention mechanisms. Output data generated by the latent diffusion model and the latent representations of the custom images are fed into the GenAI model for fine-tuning. In some instances, the fine-tuning of the GenAI model can be based on a loss function.

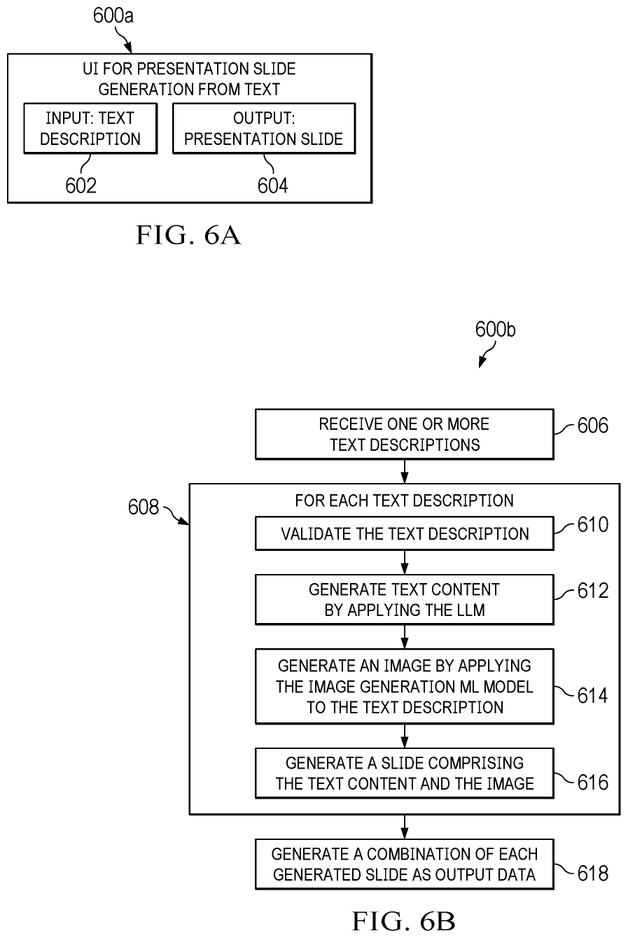

FIGS. 6A-6B show diagrams illustrating an example AI service for automatic presentation slide creation, according to some aspects of the present disclosure. FIG. 6A illustrates an example UI 600a associated with the AI service for automatic presentation slide creation. In some implementations, in addition to creating new presentation slides, this AI service can also be used to format existing slides to make the existing slides in compliance with predetermined guidelines. FIG. 6B illustrates an example flowchart of a method 600b for providing the AI service for automatic presentation slide creation.

The UI 600a can be an example of the AI service-specific input interface as described with respect to 308 of FIG. 3. As shown in FIG. 6A, the UI 600a includes an input text box 602, which is configured to receive input data for the AI service for automatic presentation slide creation from a user (e.g., the user 102 of FIG. 1). In some implementations, the input data includes one or more text descriptions. Each of the one or more text description may describe a page of a desired presentation. In some implementations, the UI 600a further includes an output box 604, which is configured to present one or more generated slides to the user. Additional UI elements may also be available, including those usable to download the output locally or to a specific location.

The method 600b can be performed by an AI service module (e.g., one of the AI service modules 110a-110n of FIG. 1) of a no-code AI system (e.g., the system 100 of FIG. 1) described in the present disclosure. The method 600b begins at operation 606, where the AI service module receives one or more text descriptions, each describing a page of a desired presentation. In some implementations, the system receives the one or more text descriptions through an AI—specific input interface (e.g., the input text box 602 of FIG. 6A) presented via a front end (e.g., the front end 104 of FIG. 1) and forwards the one or more text descriptions to the AI service module (e.g., through the API gateway 108 of FIG. 1).

Operation 608 is iterated for each of the one or more text descriptions (i.e., for each page of the desired presentation). Operation 608 includes operations 610, 612, 614, and 616. At operation 610, the AI service module validates the text description based on predetermined guidelines. The predetermined guidelines can be a set of standards or rules established by a company to regulate content (such as text, images, and presentation slides) associated with the company. For example, for branding purposes, the company may require its employees to apply uniform styles (e.g., specific layouts or templates, background styles, font, and color combinations) to their presentation slides. In another example, the company may have policies that prohibit use of certain text or images (e.g., sensitive or abusive languages) in internal documents.

At operation 612, the AI service module generates text content (for a current page) by applying a large language model (LLM) to the text description. The LLM model can be a suitable GenAI model known in the art, such as Chat Generative Pre-trained Transformer (ChatGPT), that can generate more text content based on a given text description.

At operation 614, the AI service module generates an image (for the current page) by applying an image generation ML model to the text description. The image generation ML model can be obtained by fine-tuning a pre-trained GenAI model (e.g., in a way similar to what is described with respect to FIG. 5C).

At operation 616, the AI service module generates a slide (for the current page) by combining the text content generated at operation 612 and the image generated at operation 614.

After generating a slide for each of the one or more text descriptions, the method 600b proceeds from operation 608 to operation 618. At operation 618, the AI service module combines each slide generated at operation 616. The system can provide a combination of the generated slides as output data for presentation via an interface (e.g., the output box 604 of FIG. 6A) presented at the front end.

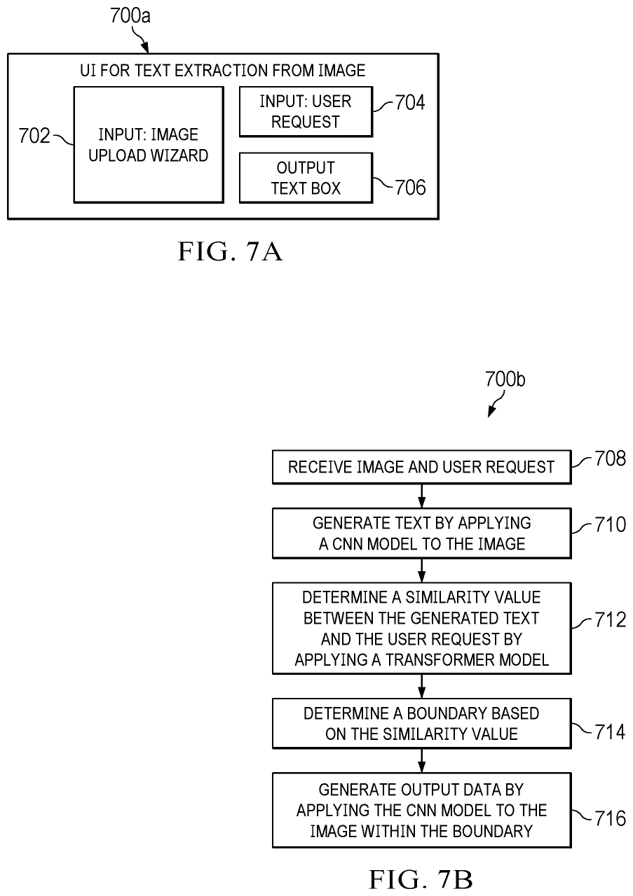

FIGS. 7A-7B show diagrams illustrating an example AI service for text extraction from image, according to some aspects of the present disclosure. FIG. 7A illustrates an example UI 700a associated with the AI service for text extraction from image. FIG. 7B illustrates an example flowchart of a method 700b for providing the AI service for text extraction from image.

The UI 700a can be an example of the AI service-specific input interface as described with respect to 308 of FIG. 3. The UI 700a is configured to receive input data for the AI service for text extraction from an image for a user (e.g., the user 102 of FIG. 1). In some implementations, the input data can include a user request and an image. As shown in FIG. 7A, the UI 700a includes an input image box 702, which is configured to receive the image of the input data. In some implementations, the input image box 702 can be an image upload wizard that allows the user to upload an image file from a local machine, a web link, or a cloud server. The UI 700a also includes an input text box 704, which is configured to receive the user request of the input data. The UI 700a further includes an output text box 706, which is configured to present output data to the user.

The method 700b can be performed by an AI service module (e.g., one of the AI service modules 110a-110n of FIG. 1) of a no-code AI system (e.g., the system 100 of FIG. 1) described in the present disclosure. The method 700b begins at 708, where the AI service module receives an image and a user request. In some implementations, the system receives the image and the user request through an AI-specific input interface (e.g., the input image box 702 and the input text box 704 of FIG. 7A) presented via a front end (e.g., the front end 104 of FIG. 1) and forwards the image and the user request to the AI service module (e.g., through the API gateway 108 of FIG. 1).

At 710, the AI service module generates text by applying a convolutional neural network (CNN) model to the image.

At 712, the AI service module determines a similarity value between the generated text and the user request by applying a transformer model.

At 714, the AI service module determines a boundary based on the similarity value.

At 716, the AI service module generates output data by applying the CNN model to the image within the boundary. The system can provide the output data for presentation via an interface (e.g., output text box 706 of FIG. 7A) presented at the front end.

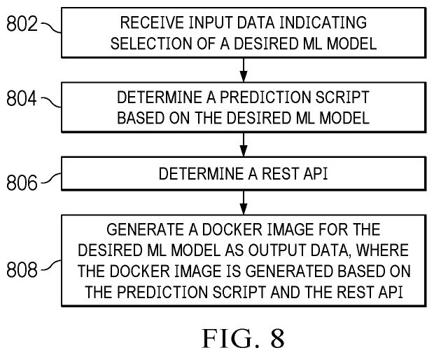

FIG. 8 illustrates an example flowchart of a method 800 for providing an example AI service for automatic ML model deployment, according to some aspects of the present disclosure. In automated ML operations (Auto ML OPS), tools can be used to automate various stages of a ML workflow to make ML more accessible. In some instances, a user may want to quickly deploy a ML model for an on-the-fly deployment. The AI service for automatic ML model deployment can help the user and make the deployment easy and simple (e.g., by clicking buttons) using containerization techniques to generate a container or an application that can be hosted in any suitable place and deployed in any suitable platform. The method 800 can be performed by an AI service module (e.g., one of the AI service modules 110a-110n of FIG. 1) of a no-code AI system (e.g., the system 100 of FIG. 1) described in the present disclosure. The method 800 begins at 802, where the AI service module receives input data indicating selection of a desired ML model. The desired ML model can be one of a pre-trained custom ML model or a ML model associated with one of AI services provided by the no-code AI system. In some implementations, the system can provide a list of available ML models for presentation via a front end (e.g., the front end 104 of FIG. 1). A user of the system can select the desired ML model from the list of available ML models through the front end. The system then forwards the input data to the AI service module (e.g., through the API gateway 108 of FIG. 1).

At 804, the AI service module determines a prediction script based on the desired ML model.

At 806, the AI service module determines a representational state transfer (REST) API for the desired ML model.

At 808, the AI service module generates a docker image of the desired ML model based on the prediction script and the REST API. In general, the docker image of the desired ML model contains application codes, libraries, tools, dependencies, and other files to make the desired ML model run. The system can provide the generated docker image as output data for presentation via the front end.

As described with respect to FIGS. 5A-5C, 6A-6B, 7A-7B, and 8, the user has selected one of the AI services from the plurality of available services, and through relatively simple inputs, is able to receive the benefits of each of the available services without coding, programming, or managing the AI or ML service, themselves.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving a first request associated with a plurality of artificial intelligence (AI) services, wherein each of the plurality of AI services is associated with one or more of a plurality of machine learning (ML) models, and wherein at least one of the plurality of ML models is trained by predetermined guidelines;
providing for presentation, via a front end, the plurality of AI services;
receiving a user input through the front end, wherein the user input indicates selection of one of the plurality of AI services;
providing for presentation, via the front end, an AI service-specific input interface, wherein each of the plurality of AI services is associated with a corresponding AI service-specific input interface;
receiving input data for the selected AI service through the AI service-specific input interface presented via the front end;
in response to receiving the input data, generating output data by applying one or more ML models associated with the selected AI service to the input data; and
providing for presentation, via the front end, the output data.

2. The method of claim 1, wherein:
the selected AI service comprises a first service for automatic image generation;
the input data comprises a text description of a desired image; and
the first service is associated with an image generation ML model trained by the predetermined guidelines.

3. The method of claim 2, wherein generating the output data comprises, in response to determining selection of the first service:
validating the text description based on the predetermined guidelines; and
generating an image as the output data by applying the image generation ML model to the text description.

4. The method of claim 1, wherein:
the selected AI service comprises a second service for automatic presentation slide creation;
the input data comprises one or more text descriptions, each describing a page of a desired presentation; and
the second service is associated with a large language model (LLM) and an image generation ML model, the image generation ML model being trained by the predetermined guidelines.

5. The method of claim 4, wherein generating the output data comprises, in response to determining selection of the second service:
for each text description of the one or more text descriptions:
validating the text description based on the predetermined guidelines;
generating text content by applying the LLM to the text description;
generating an image by applying the image generation ML model to the text description; and
generating a slide comprising the text content and the image; and
generating a combination of each generated slide as the output data.

6. The method of claim 1, wherein:
the selected AI service comprises a third service for text extraction from image;
the input data comprises a user request and an image; and
the third service is associated with a convolutional neural network (CNN) model and a transformer model.

7. The method of claim 6, wherein generating the output data comprises, in response to determining selection of the third service:
generating text by applying the CNN model to the image;
determining a similarity value between the generated text and the user request by applying the transformer model to the generated text and the user request;
determining a boundary based on the similarity value; and
generating the output data by applying the CNN model to the image within the boundary.

8. The method of claim 1, wherein the selected AI service comprises a fourth service for data mining, and wherein the fourth service comprises one or more of following functions: regression, classification, time series forecasting, or clustering.

9. The method of claim 1, wherein the selected AI service comprises a fifth service for statistical analysis, and wherein the fifth service comprises one or more of following functions: data distribution, anomaly, missing values, data drift, correlation matrix, mean, median mode, or business intelligence (BI) data analysis.

10. The method of claim 1, wherein:
the selected AI service comprises a sixth service for automatic ML model deployment;
the input data indicates selection of a desired ML model; and
generating the output data comprises, in response to determining selection of the sixth service:
determining a prediction script based on the desired ML model;
determining a representational state transfer (REST) application programming interface (API); and
generating a docker image for the desired ML model as the output data, wherein the docker image is generated based on the prediction script and the REST API.

11. The method of claim 1, further comprising:
updating the plurality of AI services;
receiving a second request associated with the updated plurality of AI services; and
providing for presentation, via the front end, the updated plurality of AI services.

12. The method of claim 11, wherein updating the plurality of AI services comprises one or more of:
adding a new AI service to the plurality of AI services and adding one or more new ML models associated with the new AI service to the plurality of ML models;
removing an AI service from the plurality of AI services and removing one or more ML models associated with the removed AI service from the plurality of ML models;
replacing one or more ML models associated with one of the AI services with one or more new ML models; or
replacing the predetermined guidelines with new guidelines and updating the at least one of the plurality of ML models by training the at least one of the plurality of ML models using the new guidelines.

13. A system comprising:
one or more computers; and
one or more storage devices storing instructions that when executed by the one or more computers cause the one or more computers to perform operations comprising:
receiving a request associated with a plurality of artificial intelligence (AI) services, wherein each of the plurality of AI services is associated with one or more of a plurality of machine learning (ML) models, and wherein at least one of the plurality of ML models is trained by predetermined guidelines;
providing for presentation, via a front end, the plurality of AI services;
receiving a user input through the front end, wherein the user input indicates selection of one of the plurality of AI services;
providing for presentation, via the front end, an AI service-specific input interface, wherein each of the plurality of AI services is associated with a corresponding AI service-specific input interface;
receiving input data for the selected AI service through the AI service-specific input interface presented via the front end;
in response to receiving the input data, generating output data by applying one or more ML models associated with the selected AI service to the input data; and
providing for presentation, via the front end, the output data.

14. The system of claim 13, wherein:
the selected AI service comprises a first service for automatic image generation;
the input data comprises a text description of a desired image; and
the first service is associated with an image generation ML model trained by the predetermined guidelines.

15. The system of claim 14, wherein generating the output data comprises, in response to determining selection of the first service:
validating the text description based on the predetermined guidelines; and
generating an image as the output data by applying the image generation ML model to the text description.

16. The system of claim 13, wherein:
the selected AI service comprises a second service for automatic presentation slide creation;
the input data comprises one or more text descriptions, each describing a page of a desired presentation; and
the second service is associated with a large language model (LLM) and an image generation ML model, the image generation ML model being trained by the predetermined guidelines.

17. The system of claim 16, wherein generating the output data comprises, in response to determining selection of the second service:
for each text description of the one or more text descriptions:
validating the text description based on the predetermined guidelines;
generating text content by applying the LLM to the text description;
generating an image by applying the image generation ML model to the text description; and
generating a slide comprising the text content and the image; and
generating a combination of each generated slide as the output data.

18. The system of claim 13, wherein:
the selected AI service comprises a third service for text extraction from image;
the input data comprises a user request and an image; and
the third service is associated with a convolutional neural network (CNN) model and a transformer model.

19. The system of claim 18, wherein generating the output data comprises, in response to determining selection of the third service:
generating text by applying the CNN model to;
determining a similarity value between the generated text and the user request by applying the transformer model to the generated text and the user request;
determining a boundary based on the similarity value; and
generating the output data by applying the CNN model to the image within the boundary.

20. One or more non-transitory computer-readable storage media storing instructions that when executed by one or more computers cause the one or more computers to perform operations comprising:
receiving a request associated with a plurality of artificial intelligence (AI) services, wherein each of the plurality of AI services is associated with one or more of a plurality of machine learning (ML) models, and wherein at least one of the plurality of ML models is trained by predetermined guidelines;
providing for presentation, via a front end, the plurality of AI services;
receiving a user input through the front end, wherein the user input indicates selection of one of the plurality of AI services;
providing for presentation, via the front end, an AI service-specific input interface, wherein each of the plurality of AI services is associated with a corresponding AI service-specific input interface;
receiving input data for the selected AI service through the AI service-specific input interface presented via the front end;
in response to receiving the input data, generating output data by applying one or more ML models associated with the selected AI service to the input data; and
providing for presentation, via the front end, the output data.
